(19) United States
(12) Patent Application Publication
(10) Pub. No.: US 2017/0299842 A1
(43) Pub. Date: Oct. 19, 2017

(54) ELECTRONIC BINOCULARS

(71) Applicant: John G. Posa, Ann Arbor, MI (US)

(72) Inventor: John G. Posa, Ann Arbor, MI (US)

(21) Appl. No.: 15/588,664

(22) Filed: May 7, 2017

Related U.S. Application Data
(63) Continuation-in-part of application No. 13/209,025, filed on Aug. 12, 2011, now Pat. No. 9,661,232.
(60) Provisional application No. 61/373,044, filed on Aug. 12, 2010.

(51) Int. Cl. G02B 7/09; G02B 23/18; H04N 5/232

(52) U.S. Cl. CPC G02B 7/09; H04N 5/23293; G02B 23/18; H04N 5/23254

(57) ABSTRACT

Methods and apparatus enable an image-viewing system to automatically zoom in and out as target subset matter is tracked. A hand-held body with a lens gathers an image including target subject matter. An image sensor having a resolution in pixels receives the image, and a viewfinder displays at least a portion of the image received by the image sensor. By virtue of the invention, apparatus for automatically zooming out the image displayed in the viewfinder if relative movement is detected between the target subject matter and the body and, and automatically zooming in the image displayed in the viewfinder if the relative movement of the target subject matter slows down or becomes stationary. A power zoom lens may effectuate the automatic zooming, or the zooming may be accomplished digitally without moving parts. The body may form part of a camera, video recorder, binoculars or telescope.

### REFERENCE TO RELATED APPLICATION

This application is a continuation-in-part of U.S. patent application Ser. No. 13/209,025, filed Aug. 12, 2011, now U.S. Pat. No. 9,661,232, which claims priority from U.S. Provisional Patent Application Ser. No. 61/373,044, filed Aug. 12, 2010, the entire content of both applications being incorporated herein by reference.

### FIELD OF THE INVENTION

This invention relates generally to still and video-image gathering and, in particular, to apparatus and methods providing automatic zoom functions in conjunction with pan or tilt actions.

### BACKGROUND OF THE INVENTION

There are situations wherein the user of image-gathering apparatus wishes to zoom in on stationary subject matter, then zoom out if the subject matter moves to maintain tracking of an object. As one example, bird watchers may wish to use maximum magnification for a resting bird, zoom out to follow the bird to a new perch, then zoom in again. Another example is sports, wherein a viewer may wish to zoom in during the snap of a football then zoom out when the ball is thrown. While a user may perform these zoom-in/zoom-out functions manually, automation would allow the user to concentrate on subject matter as opposed to equipment settings.

### SUMMARY OF THE INVENTION

This invention resides in methods and apparatus that enable an image-viewing system to automatically zoom in and out as target subset matter is tracked. A system according to the invention comprises a hand-held body with a lens to gather an image including target subject matter. An image sensor having a resolution in pixels receives the image, and a viewfinder displays at least a portion of the image received by the image sensor. By virtue of the invention, apparatus for automatically zooming out the image displayed in the viewfinder if relative movement is detected between the target subject matter and the body and, and automatically zooming in the image displayed in the viewfinder if the relative movement of the target subject matter slows down or becomes stationary.

The system may further include a plurality of display buffers storing versions of the image gathered over time, so that the relative movement of the target subject matter may be detected by comparing changes the images stored in display buffers. The system may also include auto-focus and/or image recognition hardware or software to detect the relative movement or assist in detecting the relative movement. The system may further include an accelerometer or tilt sensor to detect or assist in detecting the relative movement. A power zoom lens may effectuate the automatic zooming, or the zooming may be accomplished digitally without moving parts. The body may form part of a camera, video recorder, binoculars or telescope, and a memory may be included for recording the gathered image.

A digital embodiment of the invention includes an image sensor having a resolution in pixels for receiving the image with a viewfinder for displaying at least a portion of the image received by the image sensor. A processor is operative to digitally zoom in by utilizing a subject of the image sensor pixels to gather the image, thereby magnifying a portion of the image displayed in the viewfinder. The system in this case automatically digitally zooms out if relative movement is detected between the body and the target subject matter, and automatically digitally zooms in if the subject matter slows down or becomes stationary relative to the movement of the body. As with other embodiments, the hand-held body may form part of a camera, video recorder, binoculars or telescope.

### BRIEF DESCRIPTION OF THE DRAWINGS

FIGS. 1A-1H illustrate the way in which the invention operates;

FIG. 2 shows a representative block diagram of apparatus according to the invention;

FIGS. 3A-3D illustrate the way in which an all-digital embodiment of the invention might operate;

FIG. 4A shows a viewfinder of a camera, telescope, binoculars or other optical instrument;

FIG. 4B shows what the system will do if the subject falls outside the central (X) area;

FIG. 4C shows that an icon such a multi-headed arrow may be used, with one or more of the arrows lighting up or blinking;

FIG. 5 is a block diagram of an embodiment of the invention in the form of electronic binoculars including optical zoom;

FIG. 6 is a block diagram of an embodiment of the invention in the form of electronic binoculars including digital zoom;

FIG. 7A is a perspective view of an embodiment of the invention using a smartphone;

FIG. 7B is a perspective view of the embodiment of FIG. 7A showing a stereoscopic 3D display; and

FIG. 8 is a block diagram of a smartphone-based embodiment of the invention.

### DETAILED DESCRIPTION OF THE INVENTION

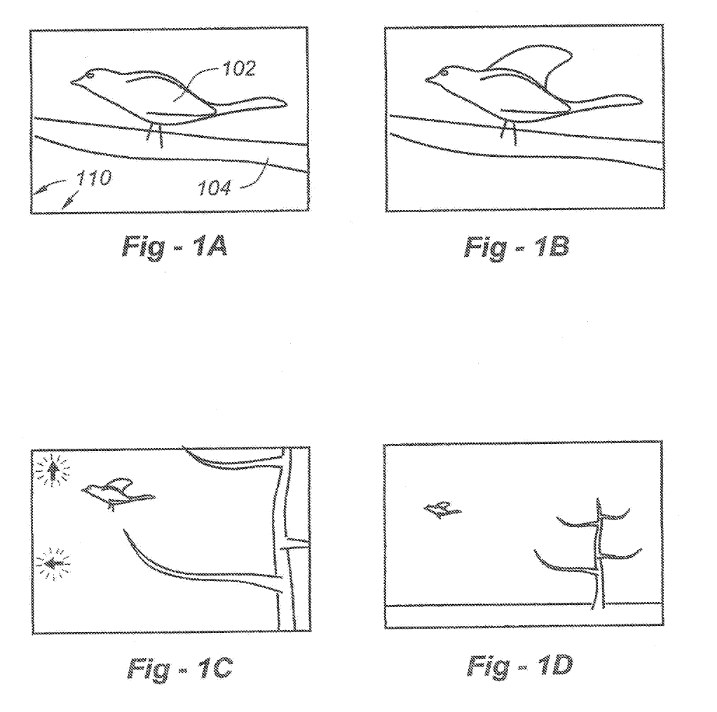

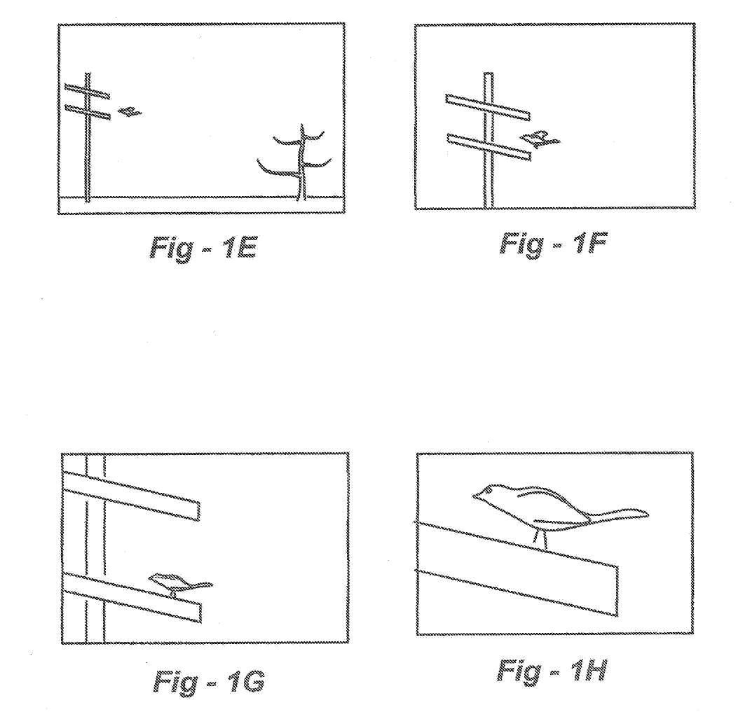

FIGS. 1A through 1H illustrate the way in which the invention operates. In FIG. 1A, a user is viewing a relatively stationary object, in this example a bird 102 on a branch 104. Reference 110 designates the field of view of the apparatus, which may be a still camera, a video camera, a telescope, binoculars or any other device used to track an object that stops and goes, whether or not the image is recorded. In FIG. 1B, the bird is beginning to take flight, and in FIG. 1C the bird leaves the branch. In accordance with the invention, at some point the apparatus automatically zooms out, enabling the user to see a wider field of view and follow the target. In FIGS. 1D and 1E, the apparatus automatically zooms out further. In FIG. 1F, as the bird finds a new perch and slows down, the apparatus may automatically zoom back in. If the bird remains stationary, the apparatus may continue to zoom in to a maximum desired extent for the highest magnification.

In FIGS. 1A-1H, the subject matter being tracked, in this case the bird 102, is not in the center of the field of view but it may be centered depending upon the embodiment and operator control. Different embodiments will now be described in detail.

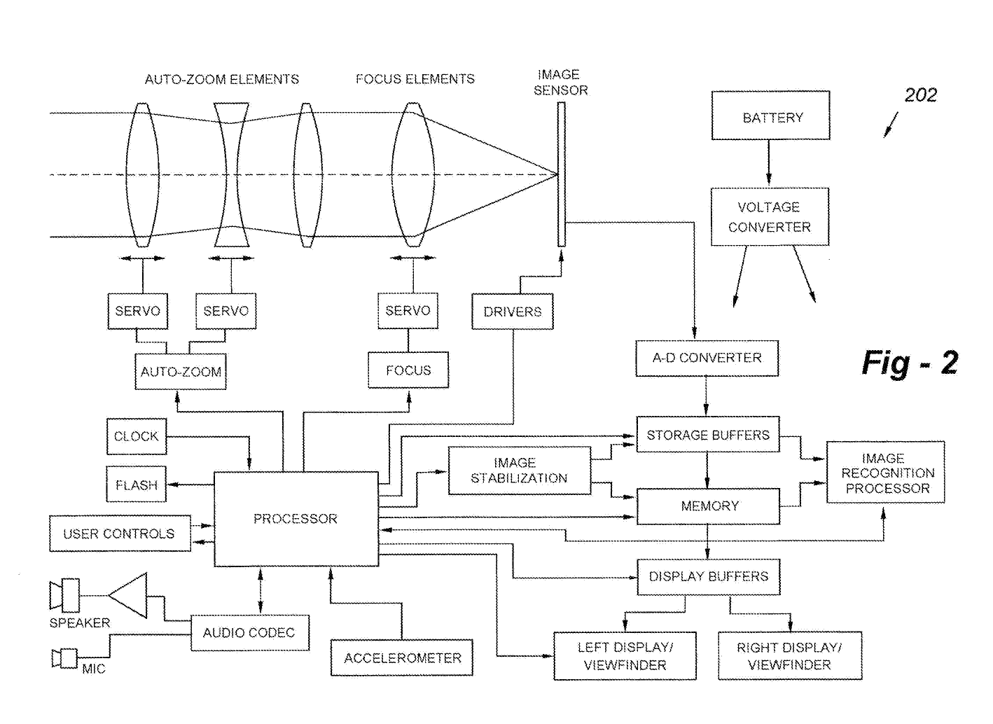

FIG. 2 is a representative block diagram of apparatus according to the invention. The diagram may represent a camera or video recorder with the understanding that different modules may be included or excluded depending upon the applications and/or desired capabilities. The diagram would be applicable to different apparatus with appropriate modification; for example, with recording binoculars two lenses would be used. With three-dimensional recording apparatus two lenses and image sensors might be used, and so forth.

In FIG. 2, an image is formed onto the image sensor through lens assembly 202. The lens assembly uses auto-zoom elements moved by one or more servos or other mechanisms. The lens typically further includes one or more elements for auto focusing using any known or yet to be developed technology. The gathered image is converted as necessary, buffered and stored if the apparatus is a recording apparatus. For playback or view-finding, the image frame(s) buffered and displayed on a screen coupled or attached to the apparatus.

Having identified target subject matter in a relatively static field of view, the inventive apparatus can determine if the target begins to move within or leave the field of view, in which case the apparatus automatically zooms out if such capability is user enabled. Not only should the auto zoom-out/-in function be under user control, the operator may preferably also set or adjust maximum zoom in, maximum zoom out and the rate of zoom relative to the movement of the subject matter in accordance with the invention.

Continuing the reference to FIG. 2, the apparatus may optionally include image stabilization circuitry or software to reduce hand-held jitter, particularly at higher levels of magnification. It is assumed that if such stabilization circuitry is present is works on concert with the image recognition and auto zoom-in/-out capability. More particularly, while the image stabilization circuitry recognizes when an entire scene ‘jiggles’ relative to the image plane, the target recognition circuitry will remain capable of detecting whether the target subject matter moves apart from the scene overall. The invention also functions in conjunction with auto-focusing, in which case the auto focus may be programmed or controlled to focus on the subject matter being tracked.

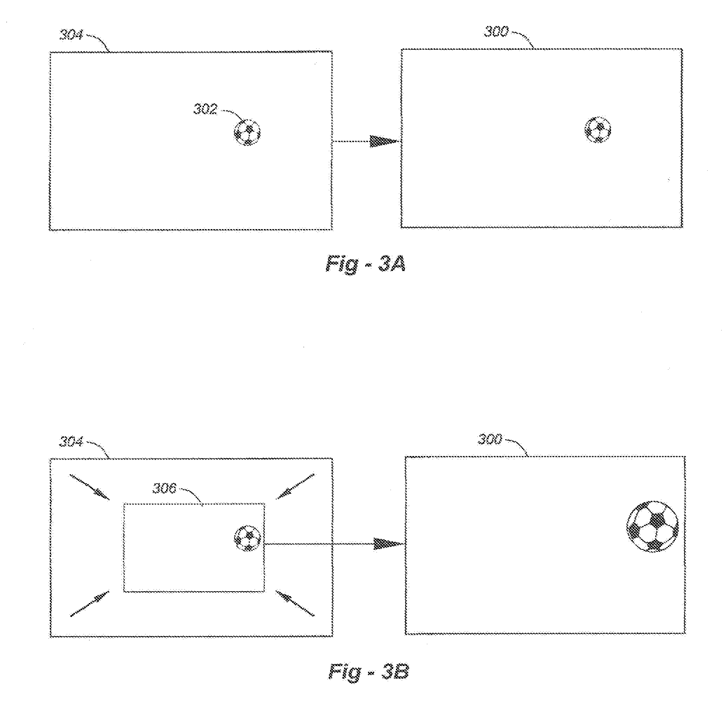

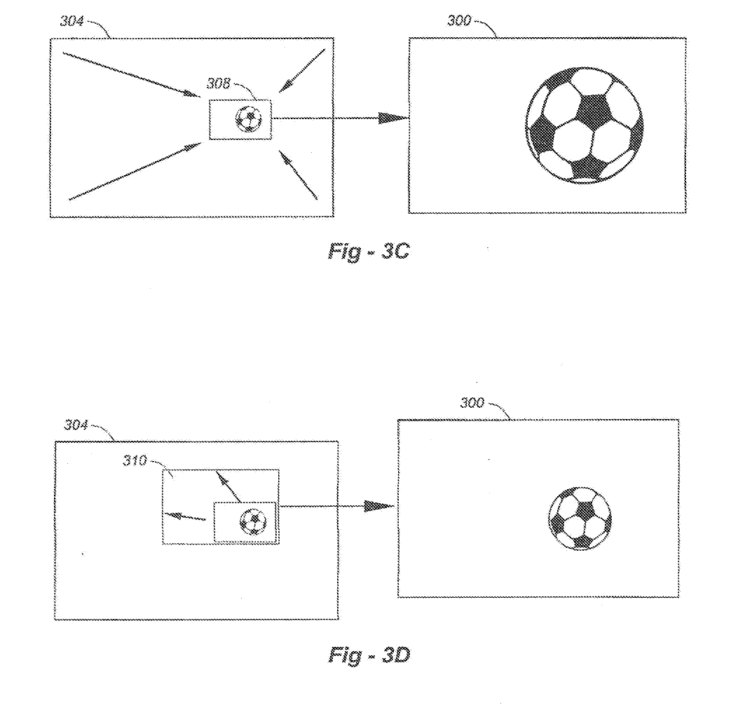

In the event that image sensor has sufficient pixels, the invention may rely upon digital zoom without moving parts. FIGS. 3A-3D illustrate the way in which an all-digital preferred embodiment of the invention might operate. The rectangles labeled 304 represent the pixels of the image sensor, whereas rectangle 300 represents the image seen through a viewfinder (and/or out put to a transmission or recording device). In FIG. 3A it is assumed that the object, in this case a soccer ball 302, has been moving but has just come to rest. The apparatus has automatically digitally zoomed out due to the movement, such that most or all of the pixels of the image sensor are being used and the resolution of the image in the viewfinder corresponds to that gathered by the image sensor.

Again, it is assumed that the object has just ceased moving. In FIG. 3B, the apparatus begins to automatically zoom in, thereby now using a subset of the 306 of the total number of pixels, thereby effectuating a digital zoom function. The image to the right in viewfinder 300 is therefore magnified. The process continues in FIG. 3C, with yet a higher degree of magnification as the user continues to view the object as it continues to remain at least relatively stationary. Fewer pixels of the image sensor 304 are used, and the scene in viewfinder 300 is more magnified. In FIG. 3D, however, the object has begun to move upwardly and to the left, and the user has begun to pan tilt in that direction. The actions of the user and/or the movement of the object is sensed in accordance with the invention, and an auto zoom-out function begins to occur, as shown in the right of FIG. 3D. To aid the user in tracking the subject matter, one or more arrows may be displayed as shown in FIG. 1C, informing the user in terms of the relative movement of the target.

Any number of image-processing technologies may be used in conjunction with the invention to carry out the zoom-in (or zoom-out) function. For example, comparisons may be made to a large portion or the entire image gathered by the image sensor over time to determine that pan/tilt movement by the user has slowed or stop, signaling the desire to zoom in. In the case of a video camera, changes based upon frame rate may be used.

If the apparatus includes image stabilization technology, relatively small changes in pan/tilt movements that would be indicative of “jiggling” would not trigger the automatic zoom function. Rather, the system would make intelligent decisions regarding user movements to distinguish between inadvertent motion and actual pan/tilt functions so that image stabilization and auto zoom could be used together, assuming both are user-enabled.

The same is true of autofocus functions. In addition to frame-frame comparisons, an autofocussing capability may be used together or separately to provide better interpretations of user intent and object tracking. For example, if a user slows down side-side and/or up-down movements and remains auto focused on a central object, it may be assumed with a higher degree of certainty that this is what the user wishes to see, thereby initiating zoom-in. Decisions may also be made automatically regarding whether or not to center the object being tracked during zoom-in/-out, depending upon the process implemented. For example, in FIG. 3B, note that the object has not been automatically centered. Particularly with auto-focus (or object recognition discussed below), the object may be optionally be automatically centered by the system, or the user may pan/tilt to center the object with such action being interpreted as centering as opposed to the need for further auto-zoom functions.

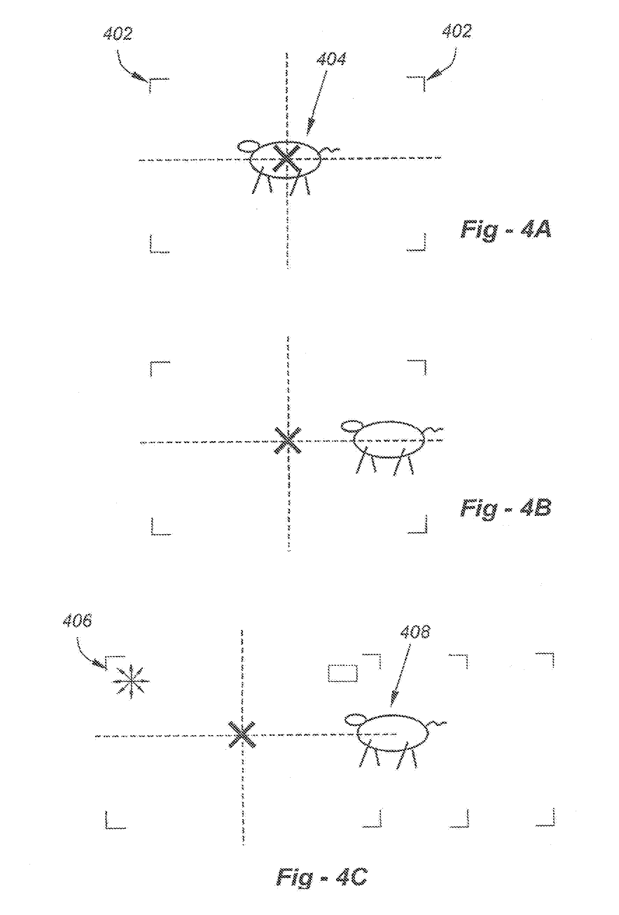

With a sufficiently large image sensor, the auto-zoom functions may be governed more by automatic object tracking than by user movements. Indeed, in some embodiments the invention is not limited to zooming out when a subject moves or zooming in when a subject is at rest. FIG. 4A shows a viewfinder of a camera, telescope, binoculars or other optical instrument at 402. A subject 404 is being viewed at or near the center of the viewfinder, as shown with the (X) identifier in the picture. According to this aspect of the invention, if the (X) continues to be superimposed over the subject, the zoom will be maintained at a particular level, such as maximum zoom, for example. According to this embodiment of the invention, however, even if the target moves, if the user continues to keep the (X) over or close to the subject, the zoom will be maintained. If the subject falls outside the central (X) area, as shown in FIG. 4B, the system will zoom out in an attempt to keep the subject in the viewfinder overall. If the user again moves the (X) over the subject, zoom will again increase. As shown in FIG. 4C, an icon such a multi-headed arrow 406 may be used, with one or more of the arrows lighting up or blinking to assist the user in finding the subject 408. Since both the subject and the viewing apparatus may be moving, a combination of image recognition and/or movement detection technologies may be used.

As with the other embodiments disclosed herein, the embodiment of FIGS. 4A-4C works well with auto-focus in the sense that the subject matter in focus in some cases may also be the target to be tracked, thereby simplifying or confirming image recognition. This is particularly true with long lenses following a subject with a shallow depth of field. In such cases the foreground and background may be out of focus which the subject being followed is in focus, thereby simplifying the object tracking process.

As a further option, an image-recognition processor, which may form part of the central processor unit, may be used in conjunction with specialized software to identify subject matter in the field of view, much like currently available face-recognition capabilities. Any technique may be used to recognize the target subject matter including comparisons with stored templates involving size, shape or color.

In alternative embodiments of the invention the apparatus may detect direct, physical movement of the camera or other apparatus as opposed to or in addition to scene changes or target identification. Referring back to FIG. 2, one or more accelerometers and/or tilt sensors may be provided to detect movement of the apparatus by the user. In such cases, when the subject matter viewed by the user begins to move outside the current field of view, movement of the camera or other device incorporating the invention is detected by the accelerometers and/or tilt sensors, causing the lens to zoom out in response to movement and zoom back in when the apparatus again becomes stabilized. While 3-axis sensors may be used, since there is virtually no movement along the axis of the lens, 2-axis sensors may suffice. Indeed, for some applications with little or no tilting, a single-axis accelerometer may be used to sense right-left movement alone.

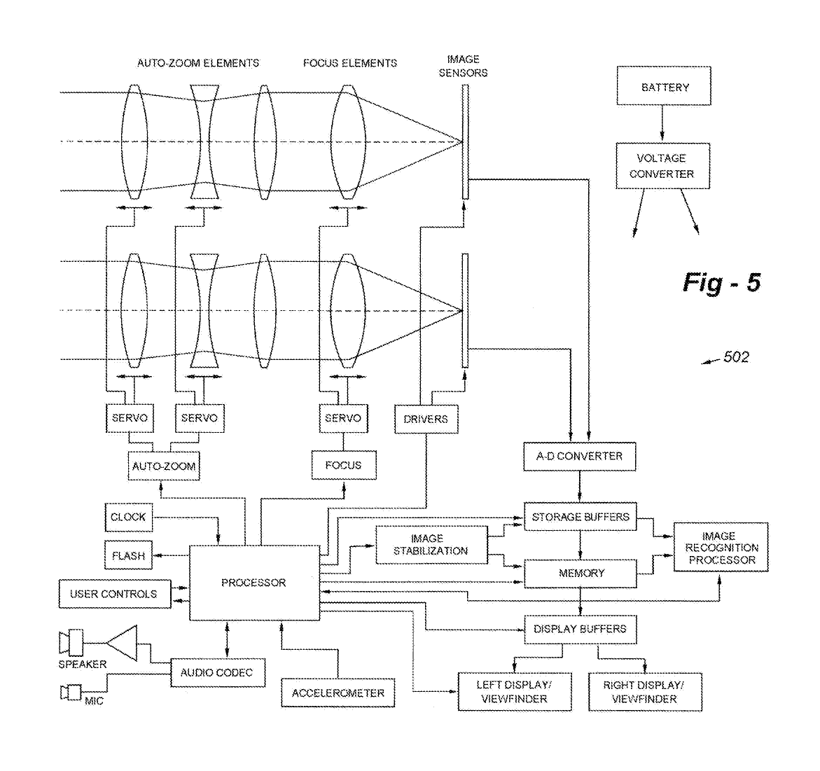

FIG. 5 is a block diagram of an electronic binoculars embodiment of the invention including optical zoom. As can be seen from this Figure, right and left optical assemblies feed right and left image sensors, the outputs of which feed right and left viewfinders. In this embodiment, all of the components shown are housed in binoculars body, including the magnifiers in the eyepieces operative to enlarge the views of the right and left displays. In the preferred embodiment, the sensors and viewfinders are capable of capturing full-motion video, with the memory(ies) being capable of storing the right and left portions of the field of view for later recall and viewing through the same or a different device. Optionally, head-tracking hardware may be provided, enabling head movements to be sensed and recorded along with the video capture, such that the device may be used to record and play back virtual reality (VR) content in the same device or other devices such as (VR) goggles.

The embodiment of FIG. 5 is capable of some or all of the auto-zoom in/out functions described in conjunction with previous Figures, however, the target subject matter will be seen as a stereoscopic image in 3D, including 3D video. If so equipped, at some point the binoculars automatically zoom out, enabling the user to see a wider field of view and follow the target. If the target slows down or stops, the binoculars automatically zoom back in. If the target remains stationary, the binoculars may continue to zoom in to a maximum desired extent for the highest magnification. All of the optional refinements described in conjunction with the camera embodiments may be available, including auto focus, vibration reduction, and the various user controls.

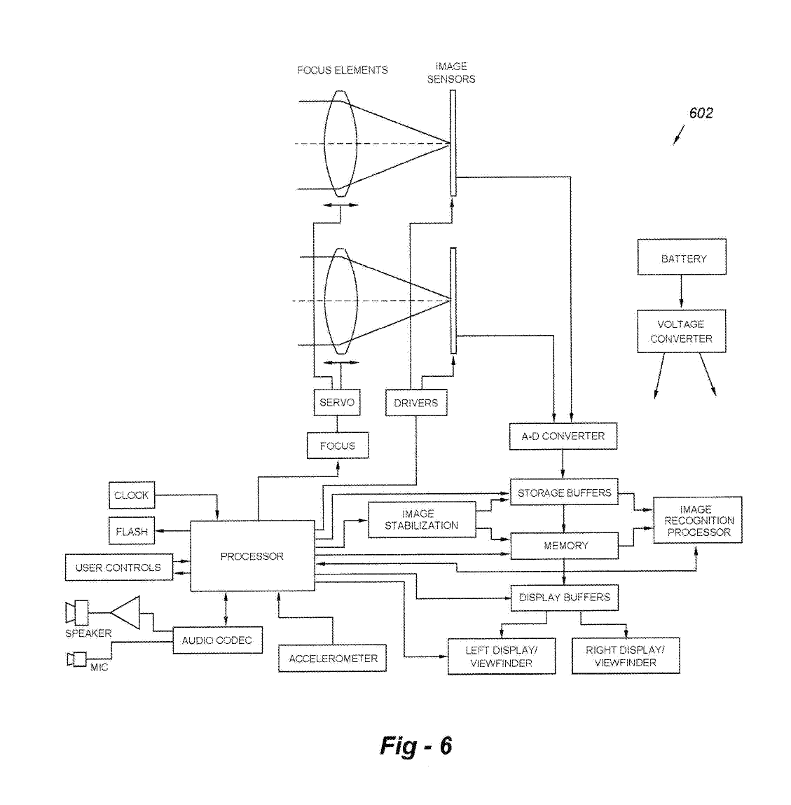

FIG. 6 is a block diagram of an embodiment of the invention in the form of electronic binoculars including digital zoom. While FIG. 5 illustrates fully optical zoom and FIG. 6 illustrates filly digital zoom with no zoom-related moving parts, it will be appreciated that a combination of optical and digital zoom may be utilized in accordance with the invention. As with FIG. 5 two image sensors are provided, for right and left perspectives, and two displays or viewfinders are shown for view the stereoscopic/3D image, whether static or moving (i.e., full motion video). In all of the video embodiments disclosed herein, the invention is not limited in terms of scan type, resolution and aspect ratio, and may take advantage of whatever video technology is available, including compression schemes.

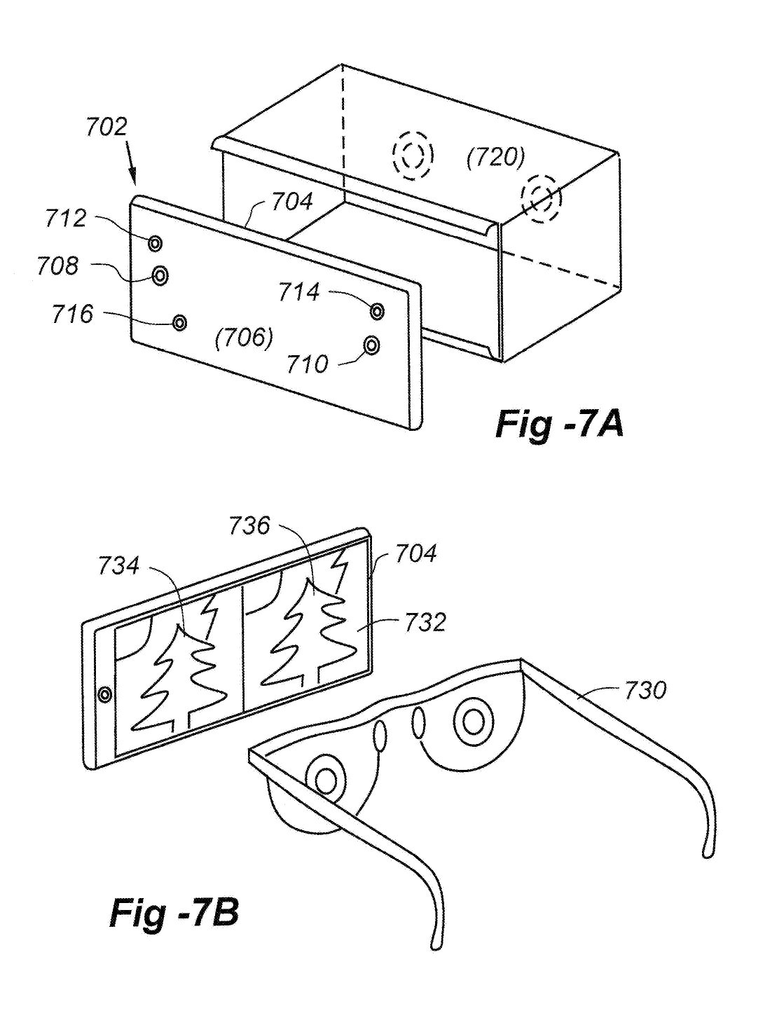

In certain embodiments of the invention, the viewfinders or image magnifiers may be provided separately from the rest of the apparatus. FIG. 7A, for example, is a perspective view of an embodiment of the invention using a smartphone 702 having a front surface 706 and a back surface 704. The front surface includes multiple cameras, including a first camera 708 capturing a right perspective and a second camera 710 capturing a left perspective of the same field of view including target subject matter. It is assumed that cameras 708, 710 are substantially the same type, and capture the same scene simultaneously. However, this does not preclude other cameras being provided on the front surface. For example, cameras 712, 714 may be provided to switch to a wider angle or more telephoto view of the stereoscopic subject matter. Other camera(s) 716 may be provided for auto-focus, bokeh effects, enhanced data, and so forth.

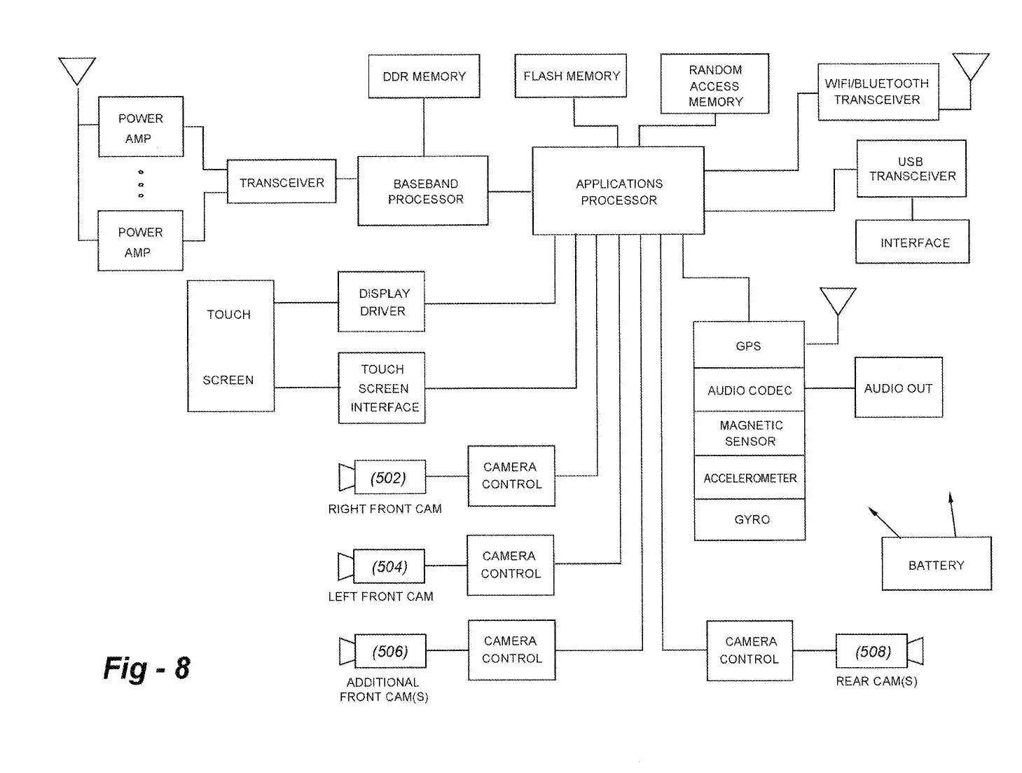

In the embodiment of FIG. 7, all of the binocular optics and electronics are contained in the smartphone 702, with the exception of the eyepieces, oculars or magnifiers, which are supported by a phone carrier 720 or, alternatively, eyeglass frames 730. Regardless, in this embodiment, the display 732 presents left and right perspectives 734, 736, which are magnified by whatever apparatus is used. FIG. 7B is a perspective view of the embodiment of FIG. 7A showing a stereoscopic 3D display. One or more front-facing cameras 740 may also be provided. FIG. 8 is a block diagram of a smartphone-based embodiment of the invention showing the various cameras, camera controls, and smartphone-based components.

I claim:

1. Electronic binoculars, comprising:
right and left optical assemblies enabling a user to view a stereoscopic video image with a field of view including target subject matter;
wherein the right optical assembly includes an objective lens and an image sensor with a resolution in pixels for gathering a right perspective of the stereoscopic video image, and a display screen with an eyepiece for viewing the right perspective of the stereoscopic video image;
wherein the left optical assembly includes an objective lens and an image sensor with a resolution in pixels for gathering a left perspective of the stereoscopic video image, and a display screen with an eyepiece for viewing the left perspective of the stereoscopic video image;
a processor in electronic communication with the image sensors, the display screens, and apparatus for automatically zooming out the stereoscopic video image to increase the field of view if relative movement is detected between the target subject matter and the binoculars keep the target subject matter within the field of view, and automatically zooming in the stereoscopic image to decrease the field of view if the relative movement between the target subject matter and the binoculars slows down or stops to increase the magnification of the target subject matter; and
wherein the automatic zooming in and out occurs regardless of the position of the target subject matter in the field of view.

2. The electronic binoculars of claim 1, wherein the apparatus for automatically zooming in and out is optical, digital or a combination thereof.

3. The electronic binoculars of claim 1, wherein the right and left optical assemblies are disposed within a common hand-held body.

4. The electronic binoculars of claim 1, wherein the processor, apparatus for zooming in and out, and the right and left optical assemblies are disposed within a smartphone with the exception of the eyepieces, which are provided separately from the smartphone.

5. The electronic binoculars of claim 4, wherein:
the smartphone has front surface with a display and a back surface with two objective lenses coupled to separate image sensors;
the display of the smartphone uses the same split screen to display the right and left perspectives of the stereoscopic video image; and
the eyepieces include magnifying optics disposed in eyeglass frames or in a holder for the smartphone.

6. The electronic binoculars of claim 1, wherein:
the stereoscopic video image has a frame rate; and
the relative movement is detected by comparing changes in the frames.

7. The electronic binoculars of claim 1, further including auto-focus apparatus to detect the relative movement.

8. The electronic binoculars of claim 1, further including image recognition apparatus to detect the relative movement.

9. The electronic binoculars of claim 1, further including an accelerometer or tilt sensor to detect the relative movement.

10. The electronic binoculars of claim 1, further including:
a memory for storing a stereoscopic video image; and
a user control operative to retrieve a stereoscopic video image stored in the memory and display the stereoscopic video image for viewing through the eyepieces.

11. The electronic binoculars of claim 10, further including:
a memory for storing a stereoscopic video image; and
a head-tracking system enabling the electronic binoculars to function as a virtual reality headset.

12. The electronic binoculars of claim 11, wherein the head movements are stored in conjunction with a stereoscopic video image enabling the electronic binoculars to function as a virtual reality recording and playback device.

13. The electronic binoculars of claim 1, wherein the rate of zoom relative to the movement of the subject matter is user-adjustable.

14. The electronic binoculars of claim 1, wherein the maximum level of zoom-in, zoom-out, or both, are user-adjustable.

15. The electronic binoculars of claim 1, further including image stabilization apparatus; and
wherein movements of the binoculars indicative of jiggling do not trigger the automatic zoom-out or zoom-in functions.

16. The electronic binoculars of claim 1, wherein the rate at which the apparatus zooms in or zooms out is proportional to the degree of the relative movement.

17. Electronic binoculars, comprising:
a smartphone having a front side with a display screen and a back side including two spaced apart cameras;
wherein one of the cameras captures a right perspective of a stereoscopic video image, and the other camera captures a left perspective of the stereoscopic video image;
a processor in the smartphone operative to display the right and left perspectives of the stereoscopic video image on the display screen as a split image; and
right and left eyepieces, separate from the smartphone, for magnifying the right and left perspectives of the stereoscopic video image on the display screen for viewing by a user.

18. The electronic binoculars of claim 17, wherein the eyepieces are provided in eyeglass frames or in a holder for the smartphone.

19. The electronic binoculars of claim 17, further including:
a memory in the smartphone for storing a stereoscopic video image; and
a user control operative to retrieve a stereoscopic video image stored in the memory and display the stereoscopic video image for viewing through the magnifiers.

20. The electronic binoculars of claim 17, further including a head-tracking system enabling the electronic binoculars to function as a virtual reality headset.
